(19) United States
(12) Patent Application Publication
(10) Pub. No.: US 2016/0217747 A1
(43) Pub. Date: Jul. 28, 2016

(54) ELECTRONIC DEVICE AND METHOD FOR IMPROVING STABILITY OF AN ELECTROPHORETIC DISPLAY OF THE ELECTRONIC DEVICE

(71) Applicant: Chiun Mai Communication Systems, Inc., New Taipei (TW)

(72) Inventor: KUI-HAO CHANG, New Taipei (TW)

(21) Appl. No.: 14/930,917

(22) Filed: Nov. 3, 2015

(30) Foreign Application Priority Data
Jan. 24, 2015 (CN) 201510037088.9

(51) Int. Cl. G09G 3/34; G02F 1/133; G02F 1/136; G02F 1/167

(52) U.S. Cl. CPC G09G 3/344; G02F 1/167; G02F 1/13306; G02F 1/136; G09G 2310/0254; G09G 2330/02

(57) ABSTRACT

An electronic device includes an electrophoretic image display (EPD) panel, a switch circuit includes a relay and a metal oxide semiconductor field effect transistor (MOS-FET), and a electrophoretic display control unit in communication with the EPD panel and the MOS-FET through a data bus. The electrophoretic display control unit can receive a touch signal when a click operation is performed on the EPD panel, drive the EPD panel to update an image displayed on the EPD panel by controlling two normally open terminals of the relay to connect two common terminals of the relay, and control two normally closed terminals of the relay to connect the two common terminals of the relay after updating the image of the EPD panel. Thus, the quality of the image displayed on the EPD panel is increased as a contrast value of the image is barely changed.

### CROSS-REFERENCE TO RELATED APPLICATIONS

This application claims priority to Chinese Patent Application No. 201510037088.9 filed on Jan. 24, 2015, the contents of which are incorporated by reference herein.

### FIELD

The subject matter herein generally relates to display technology, and particularly to improving stability of an electrophoretic display of an electronic device.

### BACKGROUND

When an electrophoretic display of an electronic device is updating an image, a contrast value of the image will decrease quickly as a common electrode of the electrophoretic display is connected to ground, the quality of the image may be affected.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device.

FIG. 2 is a diagrammatic view of one embodiment of an electrophoretic display panel of an electronic device.

FIG. 3 is a diagrammatic view of one embodiment of a switch circuit.

FIG. 4 is a diagrammatic view of one embodiment of voltage variation of a common electrode of an electrophoretic display panel.

FIG. 5 is a diagrammatic view of one embodiment of contrast changes of an image displayed on an electrophoretic display panel.

FIG. 6 is a flowchart of an example embodiment of a method for improving stability of an electrophoretic display panel.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one”. The term “comprising,” when utilized, means “including, but not necessarily limited to”, it specifically indicates open-ended inclusion or membership in the so-described combination, group, series and the like.

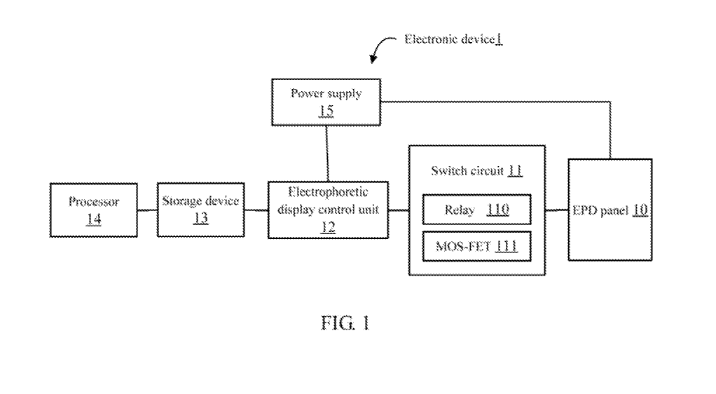

FIG. 1 is a block diagram of an example embodiment of an electronic device. In at least one embodiment, the electronic device 1 includes components, such as, an electrophoretic display (EPD) panel 10, a switch circuit 11, an electrophoretic display control unit 12, a storage device 13, at least one processor 14, and a power supply 15. In at least one embodiment, the electrophoretic display control unit 12 is coupled to the switch circuit 11, the switch circuit 11 is coupled to the EPD panel 10. The electrophoretic display control unit 12 is in communication with the EPD panel 10, the switch circuit 11, the storage device 13, and the at least one processor 14 through a data bus. FIG. 1 illustrates only one example of the electronic device 1, and other examples can include more or fewer components than those shown in the embodiment, or have a different configuration of the various components.

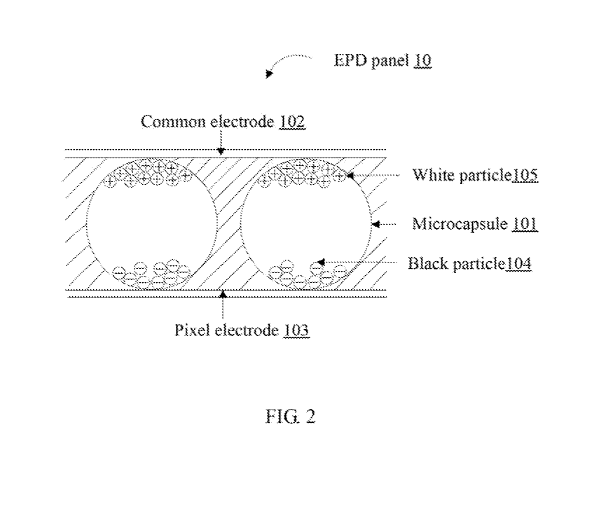

FIG. 2 is a diagrammatic view of one embodiment of an electrophoretic display panel of an electronic device. In at least one embodiment, the EPD panel 10 includes millions of tiny microcapsules 101, a common electrode 102 and a pixel electrode 103. Each microcapsule 101 includes a number of positively charged white particles 105 and a number of negatively charged black particles 104 suspended in a clear fluid. When the power supply 15 supplies a positive electric field for the EPD panel 10, the white particles 105 move to the top of the microcapsule 101 where they become visible to a viewer. When the power supply 15 supplies a negative electric field for the EPD panel 10, the black particles 105 move to the top of the microcapsule 101 where they become visible to the viewer. Thus, making the surface of the EPD panel 10 appear white or black at that spot. The polarity of the common electrode 102 is opposite to the polarity of the pixel electrode 103.

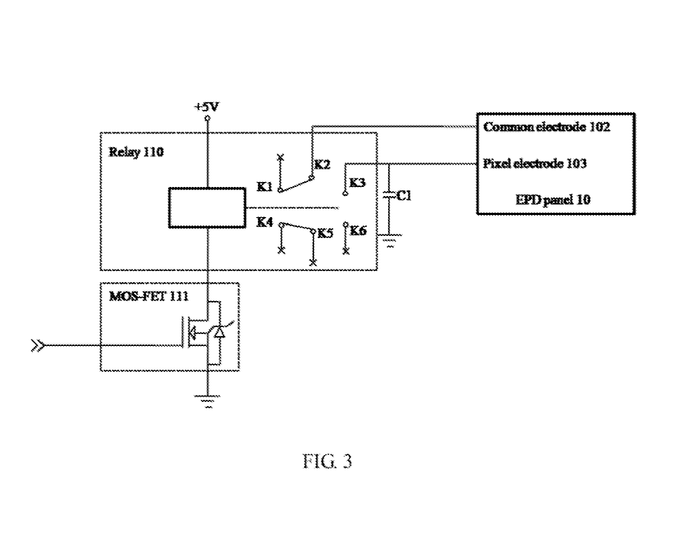

FIG. 3 is a diagrammatic view of one embodiment of a switch circuit. In at least one embodiment, the switch circuit 11 includes a relay 110 and a metal oxide semiconductor field effect transistor (MOS-FET) 111. The relay 110 is a double pole double throw (DPDT) relay with two sections including an input section and an output section.

The input section includes a coil with two terminals. For example, one terminal of the coil is connected to the power supply 15, and the other terminal of the coil is connected to the MOS-FET 111.

The output section includes six terminals which connect or disconnect mechanically. The six terminals includes two normally open (NO) terminals, such as K₂ and K₃ in FIG. 3, two normally closed (NC) terminals, such as K₅ and K₆ in FIG. 3, and two common (COM) terminals, such as K₁ and K₄ in FIG. 3. When no power supply 15 is given, the COM terminals are connected to the NC terminals. When the operating voltage is applied, the COM terminals change to connect to the NO terminals.

In at least one embodiment, one of the NO terminals is connected to the common electrode 102 of the EPD panel 10, and the other one of the NO terminals is connected to the pixel electrode 103 of the EPD panel 10. The two COM terminals are connected to the two terminals of the coil, and the two NC terminals are floating. For example, as shown in FIG. 3, one of the two NO terminals is K₂ terminal, which is connected to the common electrode 102 of the EPD panel 10. The other one of the two NO terminals is K₃ terminal, which is connected to the pixel electrode 103 of the EPD panel 10. The two NC terminals are K₅ terminal and K₆ terminal. The K₅ terminal and the K₆ terminal are floating. The two COM terminals are K₁ terminal and K₄ terminal. The K₁ terminal and the K₄ terminal are connected to the two terminals of the coil.

In at least one embodiment, the electrophoretic display control unit 12 can drive the EPD panel 10 to update an image displayed on the EPD panel 10 by controlling the K₂ terminal to connect the K₄ terminal of the relay 110, and the K₃ terminal to connect the K₁ terminal. After updating the image of the EPD panel 10, the electrophoretic display control unit 12 can control the K₅ terminal to connect the K₄ terminal, and the K₆ terminal to connect the K₁ terminal.

In at least one embodiment, the storage device 13 can include an internal storage system, such as a flash memory, a random access memory (RAM) for temporary storage of information, and/or a read-only memory (ROM) for permanent storage of information. The storage device 13 can also include an external storage system, such as an external hard disk, a storage card, or a data storage medium. In some embodiments, the storage device 13 stores a plurality of parameters and programs of the electronic device 1. The at least one processor 14 can be a central processing unit (CPU), a microprocessor, or other data processor chip that performs functions of the electronic device 1.

In at least one embodiment, the electrophoretic display control unit 12 can receive a touch signal when a click operation is performed on the EPD panel 10. The electrophoretic display control unit 12 can drive the EPD panel 10 to update an image displayed on the EPD panel 10 by controlling the two NO terminals of the relay 110 to connect the two COM terminals of the relay 110. For example, the electrophoretic display control unit 12 controls the K₂ terminal to connect the K₄ terminal, and the K₃ terminal to connect the K₁ terminal. Then, the two COM terminals and the two NO terminals of the relay 110 have continuity. When the relay 110 is powered, the MOS FET 111 is in an on condition, and the EPD panel 10 is turned on.

The electrophoretic display control unit 12 further can control the two NC terminals of the relay 110 to connect the two COM terminals of the relay 110 after updating the image of the EPD panel 10. For example, electrophoretic display control unit 12 can control the K₆ terminal to connect the K₁ terminal, and control the K₅ terminal to connect the K₄ terminal. Then, the two COM terminals and the two NO terminals of the relay 110 have continuity. When the relay 110 is powered, the MOS-FET 111 is in an off condition, and the voltage of the EPD panel 10 cannot release to the ground, the common electrode 102 of the EPD panel 10 is floating.

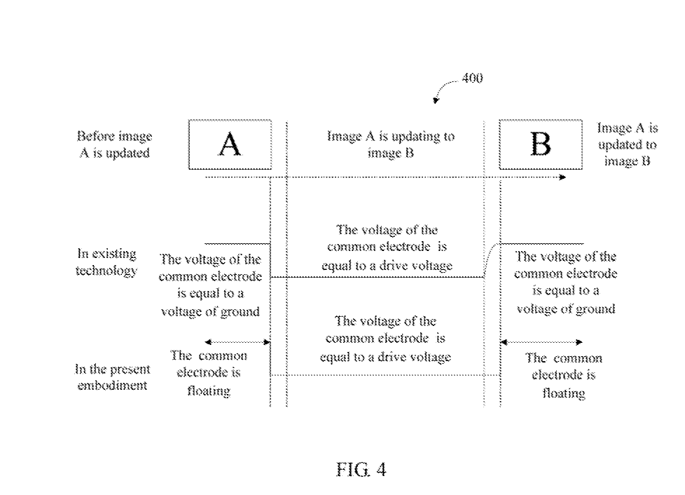

FIG. 4 is a diagrammatic view of one embodiment of voltage variation of a common electrode of the EPD panel. An example voltage 400 is provided by way of example. For example, in existing technology, a voltage of the common electrode 102 of the EPD panel 10 is equal to the voltage of ground before the EPD panel 10 updates an image A. When the EPD panel 10 is updating the image A to an image B, the power supply 15 supplies a drive voltage to the relay 110. The electrophoretic display control unit 12 drives the EPD panel 10 to update the image A, and the voltage of the common electrode 102 is equal to the drive voltage. When the image A has been updated to the image B, the voltage of the common electrode 102 is equal to the voltage of ground again.

In the present embodiment, the common electrode 102 of the EPD panel 10 is floating before the EPD panel 10 updates the image A. When the EPD panel 10 is updating the image A to an image B, the power supply 15 supplies a drive voltage to the relay 110. The electrophoretic display control unit 12 can drive the EPD panel 10 to update the image A, and the voltage of the common electrode 102 is equal to the drive voltage. When the image A has been updated to the image B, the voltage of the common electrode 102 cannot release, so the common electrode 102 is floating again.

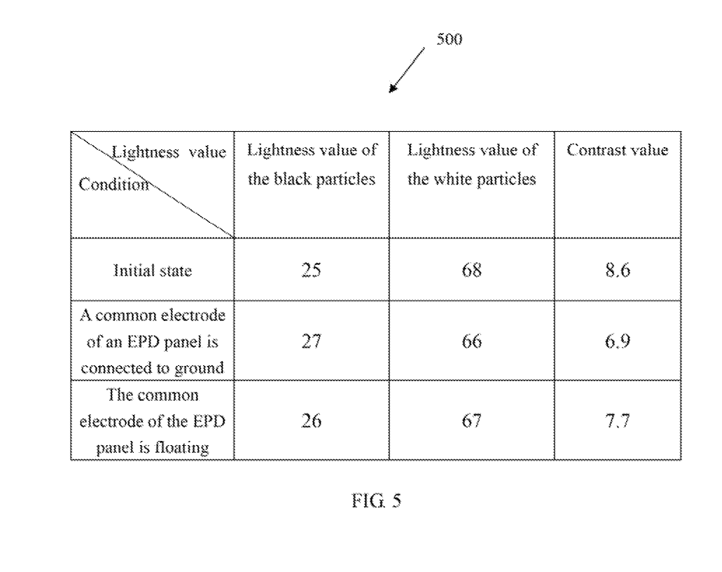

FIG. 5 is a diagrammatic view of one embodiment of contrast value changes of image displayed on the EPD panel. An example contrast value 500 is provided by way of example, when an image is shown on the EPD panel 10, a lightness value of the white particles 105 of the EPD panel 10 is 68, and a lightness value of the black particles 104 of the EPD panel 10 is 25, so the contrast value of the image is 8.6:1. As time moves on the contrast value of the image becomes smaller. For example, when the image is steadily shown on the EPD panel 10 after a duration, the lightness value of the white particles 105 of the EPD panel 10 is down to 66, and the lightness value of the black particles 104 of the EPD panel 10 is up to 27, so the contrast value of the image is 6.9:1. The contrast value is too low so that the image has too poor quality when viewed.

However, in present embodiment, the two COM terminals and the two NO terminals of the relay 110 have continuity. When the relay 110 is powered, the MOS FET 111 is in an off condition, and the voltage of the EPD panel 10 cannot release to the ground. When the image is steadily shown on the EPD panel 10 after a duration, the lightness value of the black particles 104 of the EPD panel 10 may go up to 26, and the lightness value of the white particles 105 of the EPD panel 10 may be down to 67, so the contrast value of the image is 7.7:1. The contrast value of the image is not decreased too much.

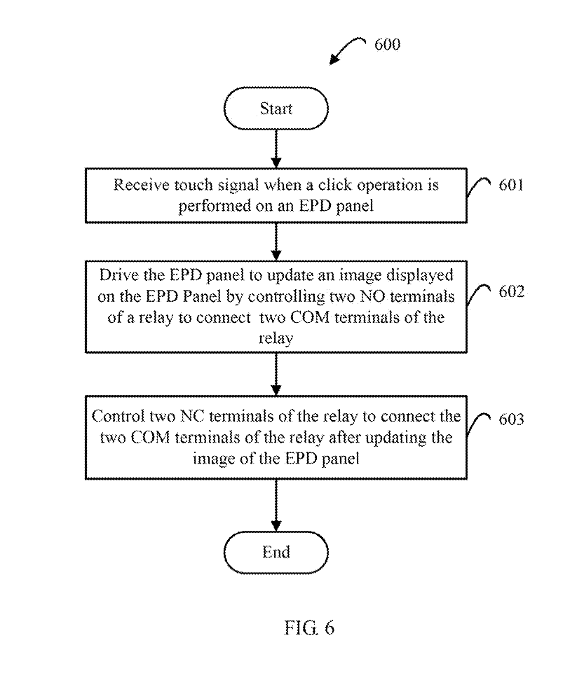

FIG. 6 is a flowchart of an example embodiment of a method for improving stability of a display of an electronic device. An example method 600 is provided by way of example, as there are a variety of ways to carry out the method. The example method 600 described below can be carried out using the configurations illustrated in FIG. 1, and various elements of these figures are referenced in explaining the example method. Each block shown in FIG. 6 represents one or more processes, methods, or subroutines, carried out in the example method 600. Furthermore, the illustrated order of blocks is illustrative only and the order of the blocks can be changed according to the present disclosure. The example method 600 can begin at block 601. Depending on the embodiment, additional blocks can be utilized and the ordering of the blocks can be changed.

At block 601, a electrophoretic display control unit 12 can receive a touch signal when a click operation is performed on the EPD panel 10.

At block 602, the electrophoretic display control unit 12 can drive the EPD panel 10 to update an image displayed on the EPD panel 10 by controlling the two NO terminals of the relay 110 to connect the two COM terminals of the relay 110. For example, the electrophoretic display control unit 12 controls the K₂ terminal to connect the K₄ terminal, and the K₃ terminal to connect the K₁ terminal. Then, the two COM terminals and the two NO terminals of the relay 110 have continuity. When the relay 110 is powered, the MOS-FET 111 is in an on condition, and the EPD panel 10 is turned on. The electrophoretic display control unit 10 can send image data to the EPD panel 10 to display the image.

At block 603, the electrophoretic display control unit 12 further can control the two NC terminals of the relay 110 to connect the two COM terminals of the relay 110 after updating the image of the EPD panel 10. For example, the electrophoretic display control unit 12 can control the K₆ terminal to connect the K₁ terminal, and the K₅ terminal to connect the K₄ terminal. Then, the two COM terminals and the two NO terminals of the relay 110 have continuity. When the relay 110 is powered, the MOS-FET 111 is in an off condition, and the voltage of the EPD panel 10 cannot release to the ground, the common electrode 102 of the EPD panel 10 is floating.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
an electrophoretic display panel;
a switch circuit coupled to the electrophoretic display panel and comprising a relay and a metal oxide semiconductor field effect transistor (MOS-FET); and
at least one processor coupled to the electrophoretic display panel and the switch circuit, wherein the at least one processor executes a plurality of instructions to:
receive a touch signal when a click operation is performed on the electrophoretic display panel;
drive the electrophoretic display panel to update an image displayed on the electrophoretic display panel by controlling two normally open terminals of the relay to connect two common terminals of the relay; and
control two normally closed terminals of the relay to connect the two common terminals of the relay after updating the image of the electrophoretic display panel.

2. The electronic device according to claim 1, wherein the relay is a double pole double throw (DPDT) relay comprising a coil with two terminals, the two normally open terminals, the two normally closed terminals, and the two common terminals.

3. The electronic device according to claim 2, wherein one of the two normally open terminals is connected to a common electrode of the electrophoretic display panel, and the other one of the two normally open terminal is connected to a pixel electrode of the electrophoretic display panel.

4. The electronic device according to claim 2, wherein the two normally closed terminals are floating.

5. The electronic device according to claim 2, wherein one terminal of the coil is connected to the MOS-FET, and the other terminal of the coil is connected to a power supply of the electronic device.

6. The electronic device according to claim 5, wherein the MOS-FET is in an off condition when the two normally closed terminals of the relay are connected to the two common terminals of the relay, and the MOS-FET is in an on condition when the two normally open terminals of the relay are connected to the two common terminals of the relay.

7. A computer-implemented method for improving stability of a display of an electronic device comprising an electrophoretic display panel, a switch circuit coupled to the electrophoretic display panel and comprising a relay and a metal oxide semiconductor field effect transistor (MOS-FET), and at least one processor coupled to the electrophoretic display panel and the switch circuit, the method comprising:
receiving a touch signal when a click operation is performed on the electrophoretic display panel;
driving the electrophoretic display panel to update an image displayed on the electrophoretic display panel by controlling two normally open terminals of the relay to connect two common terminals of the relay; and
controlling two normally closed terminals of the relay to connect the two common terminals of the relay after updating the image of the electrophoretic display panel.

8. The method according to claim 7, wherein the relay is a double pole double throw (DPDT) relay comprising a coil with two terminals, the two normally open terminals, the two normally closed terminals, and the two common terminals.

9. The method according to claim 8, wherein one of the two normally open terminals is connected to a common electrode of the electrophoretic display panel, and the other one of the two normally open terminal is connected to a pixel electrode of the electrophoretic display panel.

10. The method according to claim 8, wherein the two normally closed terminals are floating.

11. The method according to claim 8, wherein one terminal of the coil is connected to the MOS-FET, and the other terminal of the coil is connected to a power supply of the electronic device.

12. The method according to claim 11, wherein the MOS-FET is in an off condition when the two normally closed terminals of the relay are connected to the two common terminals of the relay, and the MOS-FET is in an on condition when the two normally open terminals of the relay are connected to the two common terminals of the relay.

13. A non-transitory storage medium having stored thereon instructions that, when executed by a processor of an electronic device, causes the processor to perform a method for improving stability of display of the electronic device, the electronic device further comprising an electrophoretic display panel and a switch circuit comprising a relay and a metal oxide semiconductor field effect transistor (MOS-FET), wherein the method comprises:
receiving, a touch signal when a click operation is performed on the electrophoretic display panel;
driving the electrophoretic display panel to update an image displayed on the electrophoretic display panel by controlling two normally open terminals of the relay to connect two common terminals of the relay; and
controlling two normally closed terminals of the relay to connect the two common terminals of the relay after updating the image of the electrophoretic display panel.

14. The non-transitory storage medium according to claim 13, wherein the relay is a double pole double throw (DPDT) relay comprising a coil with two terminals, the two normally open terminals, the two normally closed terminals, and the two common terminals.

15. The non-transitory storage medium according to claim 14, wherein one of the two normally open terminals is connected to a common electrode of the electrophoretic display panel, and the other one of the two normally open terminal is connected to a pixel electrode of the electrophoretic display panel.

16. The non-transitory storage medium according to claim 14, wherein the two normally closed terminals are floating.

17. The non-transitory storage medium according to claim 14, wherein one terminal of the coil is connected to the MOS-FET, and the other terminal of the coil is connected to a power supply of the electronic device.

18. The non-transitory storage medium according to claim 17, wherein the MOS-FET is in an off condition when the two normally closed terminals of the relay are connected to the two common terminals of the relay, and the MOS-FET is in an on condition when the two normally open terminals of the relay are connected to the two common terminals of the relay.
